(19) United States
(12) Patent Application Publication
(10) Pub. No.: US 2025/0251184 A1
(43) Pub. Date: Aug. 7, 2025

(54) REFRIGERATOR

(71) Applicant: SAMSUNG ELECTRONICS CO., LTD., Suwon-si (KR)

(72) Inventors: Suhyeong LIM, Suwon-si (KR); Youngkyu MOON, Suwon-si (KR); Jaeyoun PARK, Suwon-si (KR); Seungtaek YU, Suwon-si (KR); Jaejin LEE, Suwon-si (KR)

(73) Assignee: SAMSUNG ELECTRONICS CO., LTD., Suwon-si (KR)

(21) Appl. No.: 19/085,769

(22) Filed: Mar. 20, 2025

Related U.S. Application Data
(63) Continuation of application No. PCT/KR2023/011065, filed on Jul. 28, 2023.

(30) Foreign Application Priority Data
Sep. 20, 2022 (KR) 10-2022-0118841

(51) Int. Cl. F25D 23/02

(52) U.S. Cl. CPC F25D 23/028; F25D 2323/024

(57) ABSTRACT

A refrigerator includes: a main body including a storage chamber; one or more doors pivotably coupled to the main body and configured to open and close the storage chamber; and a door-closing device configured to fix the one or more doors in a position that closes the storage chamber. The door-closing device includes: a fixing member on a top of the one or more doors and connected to the main body via a hinge; a coupling member including a pivoting part, a first arm and a second arm each extending from the pivoting part; and a shaft member on the one or more doors and coupled to the pivoting part. The coupling member is pivotable around the shaft member within a predetermined range of angles. The first arm supports a first side of the fixing member, and the second arm elastically presses a second side of the fixing member.

### CROSS-REFERENCE TO RELATED APPLICATIONS

This application is a continuation of International Application No. PCT/KR2023/011065, filed on Jul. 28, 2023, which is based on and claims priority to Korean Patent Application No. 10-2022-0118841, filed on Sep. 20, 2022, in the Korean Intellectual Property Office, the disclosures of which are incorporated by reference herein in their entireties.

### BACKGROUND

### 1. Field

The disclosure relates to a door-closing device and a refrigerator including the same.

### 2. Description of Related Art

In general, a refrigerator is a home appliance for storing food fresh for a long time by including a main body having a storage chamber for storing food, a door for opening and closing the storage chamber, and a cold air supply device for supplying cold air to the storage chamber.

The door may maintain a closed state of the door by using door closing structures installed on the main body and the door. However, the opening and closing forces of the door may not be maintained consistently due to a left/right, front/back, or up/down step that occurs if the door is installed on the main body.

### SUMMARY

Provided is a refrigerator capable of the maintaining consistent opening and closing forces of a door by eliminating steps between the door and a main body.

According to an aspect of the disclosure, a refrigerator includes: a main body including a storage chamber; one or more doors pivotably coupled to the main body and configured to open and close the storage chamber; and a door-closing device configured to fix the one or more doors in a position that closes the storage chamber, wherein the door-closing device includes: a fixing member on a top surface of the one or more doors and connected to the main body via a hinge; a coupling member including a pivoting part, a first arm extending from the pivoting part, and a second arm extending from the pivoting part; and a shaft member on the one or more doors and coupled to the pivoting part, wherein the coupling member is configured to pivot around the shaft member within a predetermined range of angles, and the first arm supports a first side of the fixing member, and the second arm elastically presses a second side of the fixing member.

The first arm may be further away from a hinge shaft of the one or more doors than the second arm.

A front end part of the second arm may be bent toward the hinge shaft of the one or more doors, and the fixing member may be between the first arm and the second arm.

The second arm may include a protruding part configured to press the fixing member in a direction in which the one or more doors closes the storage chamber, and the protruding part may protrude toward the first arm from a side surface of the second arm facing the first arm.

The fixing member may be inserted in a coupling space between the first arm and the second arm, and the protruding part may be at an entrance of the coupling space, and the entrance may be narrower than an inside of the coupling space.

The shaft member may include a stopper protruding toward a side of the shaft member, and the pivoting part may include a limiting groove into which the stopper is inserted, and a width of the limiting groove may be greater than a width of the stopper.

The shaft member may include a first stopper and a second stopper protruding toward both sides of the shaft member, the pivoting part may include a first limiting groove and a second limiting groove into which the first stopper and the second stopper are respectively inserted, a first clearance is between the first limiting groove and the first stopper and a second clearance is between the second limiting groove and the second stopper, and a length of the first stopper may be different than a length of the second stopper.

A length of the first limiting groove may correspond to the length of the first stopper, and a length of the second limiting groove may correspond to the length of the second stopper.

The shaft member may be integrated with a door cap coupled to the top surface of the one or more doors.

A door cap coupled to the top surface of the one or more doors may include a first support protrusion below the first arm and a second support protrusion below the second arm, and the first support protrusion and the second support protrusion may have a gap therebetween, the fixing member being allowed to pass through the gap.

The pivoting part may further include a plurality of contact protrusions disposed on a bottom surface of the pivoting part and contacting a seating surface of the door cap.

The fixing member may include a pillar part between the first arm and the second arm.

A lower end of the pillar part may be lower than a bottom surface of the first arm or the second arm.

According to an aspect of the disclosure, a door-closing device includes: a fixing member fixed to a hinge of a main body of a refrigerator and including a pillar part; a coupling member on a one or more doors for opening and closing a storage chamber of the main body of the refrigerator and including a first arm supporting a first side of the pillar part and a second arm supporting a second side of the pillar part; and a shaft member on the one or more doors, wherein the coupling member is pivotable around the shaft member within a predetermined range of angles, a front end part of the second arm is bent toward a hinge shaft, which is a pivot center of the one or more doors being at a portion of which the front end part of the second arm bends towards the hinge shaft, and the fixing member is between the first arm and the second arm.

The second arm may include a protruding part protruding toward the first arm from a side surface facing the first arm, the fixing member may be inserted in a coupling space between the first arm and the second arm, and the protruding part may be at an entrance of the coupling space, the entrance being narrower than an inside of the coupling space.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view of a refrigerator according to one or more embodiments of the present disclosure;

FIG. 2 is an exploded perspective view of a door-closing device including a fixing member disposed on an upper hinge and a coupling member disposed on a door cap according to one or more embodiments of the present disclosure;

FIG. 3 is a plan view of the coupling member of the door-closing device according to one or more embodiments of the present disclosure;

FIG. 4 is an enlarged view showing that the coupling member and a shaft member of the door-closing device are coupled to each other according to one or more embodiments of the present disclosure;

FIG. 5 is a view showing an example in which the coupling member of the door-closing device is pivotably coupled to the shaft member within a predetermined range of angles according to one or more embodiments of the present disclosure;

FIG. 6 is a right side view of the coupling member of the door-closing device according to one or more embodiments of the present disclosure;

FIG. 7 is a left side view of the coupling member of the door-closing device according to one or more embodiments of the present disclosure;

FIGS. 8, 9, 10, and 11 are views showing various embodiments of coupling members of the door-closing device according to one or more embodiments of the present disclosure;

FIG. 12 is a bottom view of the coupling member of the door-closing device according to one or more embodiments of the present disclosure;

FIGS. 13 and 14 are front and plan views of the coupling member of the door-closing device and a plurality of support protrusions of the door cap disposed on a lower side of the coupling member according to one or more embodiments of the present disclosure;

FIG. 15 is a view showing an example of coupling the upper hinge to a main body according to one or more embodiments of the present disclosure;

FIGS. 16, 17, 18, 19 and 20 are views showing a process in which a refrigerator compartment door closes a refrigerator compartment by using the door-closing device according to one or more embodiments of the present disclosure;

FIG. 21 is an exploded perspective view showing a coupling member of the door-closing device is coupled to the door cap according to one or more embodiments of the present disclosure;

FIG. 22 is a plan view of the coupling member of the door-closing device according to one or more embodiments of the present disclosure; and

FIGS. 23, 24, and 25 are the right side view, left side view, and bottom view of the coupling member of the door-closing device according to one or more embodiments of the present disclosure.

### DETAILED DESCRIPTION

Hereinafter, various embodiments are described in more detail with reference to the accompanying drawings. The embodiments described in the specification may be modified in various ways. A specific embodiment may be shown in the drawings and described in detail in a detailed description. However, the specific embodiment disclosed in the accompanying drawings is provided only to assist in easy understanding of the various embodiments. Therefore, it should be understood that the spirit of the present disclosure is not limited to the specific embodiment shown in the accompanying drawings, and includes all the equivalents and substitutions included in the spirit and scope of the present disclosure.

Terms including ordinal numbers such as “first” and “second” may be used to describe various components. However, these components are not limited to these terms. The terms are used only to distinguish one component and another component from each other.

It is to be understood that terms “include,” “have”, and the like used in the present disclosure specify the existence of features, numerals, steps, operations, components, parts, or combinations thereof, which are mentioned in the specification, and do not preclude the existence or addition of one or more other features, numerals, steps, operations, components, parts, or combinations thereof. It should be understood that if one component is referred to as being “connected to” or “coupled to” another component, one component may be directly connected or coupled to another component, or may be connected or coupled to another component while having a third component interposed therebetween. On the other hand, it should be understood that if one component is referred to as being “directly connected to” or “directly coupled to” another element, one element may be connected or coupled to another element without a third element interposed therebetween.

In the present disclosure, the expression “the same” may be used to indicate not only the completely same, but also the same including a difference taking into account a processing error range.

Further, in describing the present disclosure, summarized or omitted is a detailed description of a case where it is decided that the detailed description for the known functions or configurations related to the present disclosure may unnecessarily obscure the gist of the present disclosure.

Hereinafter, the description describes an example in detail with reference to the accompanying drawings to allow those skilled in the art to which the present disclosure pertains to easily implement the present disclosure. However, an example may be implemented in many different forms and is not limited to the example described herein. In the drawings, portions unrelated to the description are omitted to clearly describe an example of the present disclosure, and similar portions are denoted by similar reference numerals throughout the specification.

Hereinafter, the embodiments of the present disclosure are described in detail with reference to the accompanying drawings.

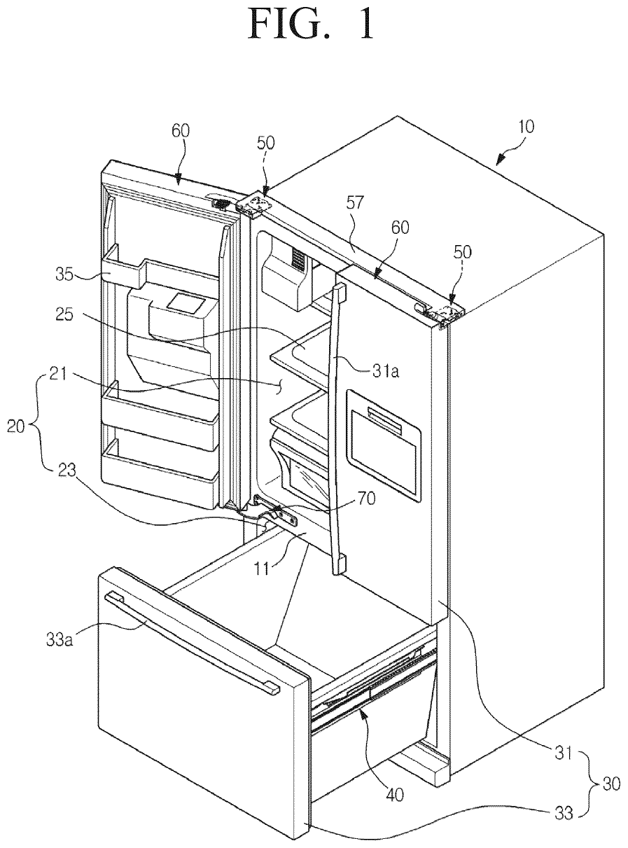

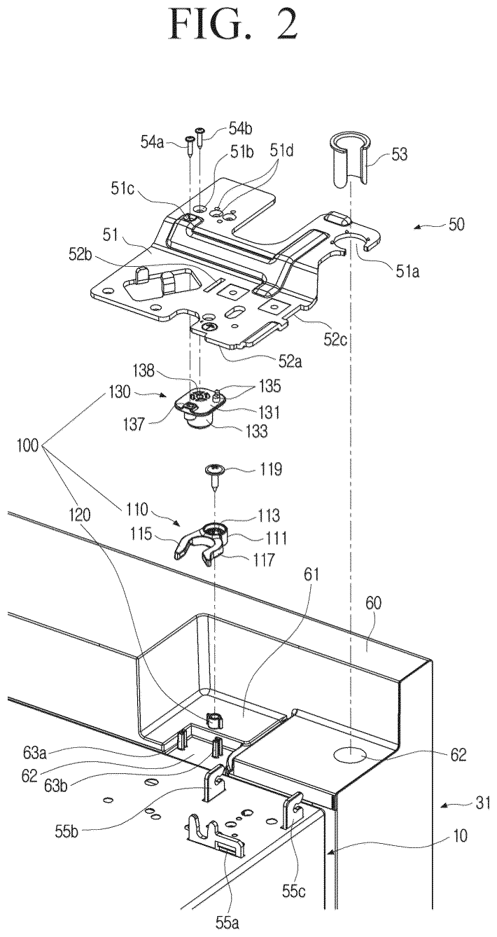

FIG. 1 is a perspective view of a refrigerator according to one or more embodiments of the present disclosure. FIG. 2 is an exploded perspective view of a door-closing device including a fixing member disposed on an upper hinge and a coupling member disposed on a door cap according to one or more embodiments of the present disclosure.

Referring to FIG. 1, a refrigerator 1 may include a main body 10, a storage chamber 20 having an open front and disposed in the main body 10, and doors 30 for opening and closing the storage chamber 20.

The refrigerator 1 may include a sliding device 40 allowing a freezer door 33 to be slidably coupled to the main body 10, the freezer door 33 being for opening and closing a freezer compartment 23 disposed at a lower part of the main body 10 among the storage chambers 20.

The refrigerator 1 may include an upper hinge 50 allowing a refrigerator compartment door 31 to be pivotally coupled to the main body 10, the refrigerator compartment door 31 being for opening and closing a refrigerator compartment 21 disposed at an upper part of the main body 10 among the storage chambers 20, a lower hinge 70 coupled to the main body 10 and pivotally coupled to a lower part of the door 30, a door cap 60 coupled to the top of the refrigerator compartment door 31, and a door-closing device 100 for transmitting a force in a direction of closing the refrigerator compartment door 31 if the refrigerator compartment door 31 is closed.

The main body 10 may include an inner case forming the storage chamber 20 and an outer case forming its outer appearance, and may include a cold air supply device for supplying cold air to the storage chamber 20. The cold air supply device may include a compressor, a condenser, an expansion valve, an evaporator, a blower fan, and a cold air duct. The cold air supply device may have an insulating material foamed between the inner case and outer case of the main body 10 to prevent cold air from leaking out of the storage chamber 20. A machine room may be disposed at a lower rear side of the main body 10, and installed with the compressor for compressing a refrigerant and the condenser for condensing the compressed refrigerant.

The storage chamber 20 may be partitioned into the upper and lower parts by a partition wall 11, and the refrigerator compartment 21 may be disposed at the upper part of the main body 10, and the freezer compartment 23 may be disposed at the lower part thereof.

The freezer compartment 23 may be opened and closed by the freezer door 33 slidably coupled to the main body 10. The freezer compartment 23 may have the sliding device 40 coupled to the freezer door 33 and each of two side walls inside the freezer compartment 23 to allow the freezer door 33 to slide relative to the main body 10.

The freezer door 33 may have a handle 33a installed thereon to allow a user to grasp the handle to open and close the freezer door 33.

The refrigerator compartment 21 may have a plurality of shelves 25 and the refrigerator compartment 21 may thus be partitioned into a plurality of parts. The refrigerator compartment 21 may be opened and closed by the refrigerator compartment door 31 pivotably coupled to the main body 10. The upper hinge 50 may be coupled to the top of the main body 10 to allow the refrigerator compartment door 31 to be pivotably coupled to the main body 10.

A hinge body 51 of the upper hinge 50 may have one side coupled to the main body 10. The hinge body 51 may include a fixing protrusion 52a inserted into a fixing groove 55a disposed in an upper surface of the main body 10, and an insertion hole 52b and an insertion groove 52c into which a plurality of fixing protrusions 55b and 55c protruding from the upper surface of the main body 10 are respectively inserted.

Referring to FIG. 2, the hinge body 51 may have the other side protruding from the main body 10 to cover to top of the door cap 60. The hinge body 51 may be connected to the door cap 60 through a hinge shaft 53 press-coupled to a coupling hole 51a disposed in the other side. The hinge shaft 53 may be pivotably inserted into a pivot hole 69 disposed in the door cap 60. The hinge shaft 53 may support the top of the refrigerator compartment door 31 in a pivotable state.

The door cap 60 may be coupled to the top of the refrigerator compartment door 31, and a plurality of guards 35 for storing food or the like may be installed on a rear surface of the refrigerator compartment door 31. Like the freezer door 33, the refrigerator compartment door 31 may have a handle 31a installed thereon to allow the user to grasp the handle 31a to open and close the refrigerator compartment door 31.

Referring to FIG. 2, the door-closing device 100 may be disposed on the upper hinge 50 and the door cap 60 and transmit the force to the refrigerator compartment door 31 in the direction of closing the refrigerator compartment door 31 if the refrigerator compartment door 31, which is pivotably coupled to the main body 10, is closed.

The door-closing device 100 may include a coupling member 110 which is disposed on the door cap 60, a shaft member 120 to which the coupling member 110 is pivotally coupled within a predetermined range of angles, and a fixing member 130 which is disposed on the upper hinge 50 and to which the coupling member 110 is elastically separably coupled.

The coupling member 110 may include a pivoting part 111 into which the shaft member 120 is inserted, and a support arm 115 and an elastic arm 117 each extending from the pivoting part 111. The support arm 115 and the elastic arm 117 may face each other and elastically grasp a pillar part 133 of the fixing member 130.

The coupling member 110 may be connected to the shaft member 120 through a single screw 56. In this way, a structure for connecting the coupling member 110 to the door cap 60 may be simply configured, thus making it easy to assemble and maintain the door-closing device 100 according to one or more embodiments of the present disclosure.

The shaft member 120 may protrude upward from a seating surface 61 of the door cap 60. The shaft member 120 may be integrated with the door cap 60 if the door cap 60 is injection molded.

The fixing member 130 may include a fixing part 131 coupled to the upper hinge 50 and the pillar part 133 extending downward from the fixing part 131. The fixing part 131 may be fixed to the bottom of the other side of the hinge body 51. In this case, the fixing part 131 may be fixed to the hinge body 51 by a plurality of screws 54a and 54b. The plurality of screws 54a and 54b may pass through a plurality of holes 51c and 51d disposed in the hinge body 51 to thus be coupled to a plurality of fastening holes 137 and 138 of the fixing part 131.

The fixing part 131 may include a plurality of coupling protrusions 135 to improve assembly and prevent misassembly in case of being coupled to the hinge body 51. For example, before coupling the fixing member 130 to the hinge body 51, the hinge body 51 and the fixing part 131 may be fastened to each other by using the plurality of screws 54a and 54b while the plurality of coupling protrusions 135 are inserted into the plurality of holes 51d disposed in the hinge body 51.

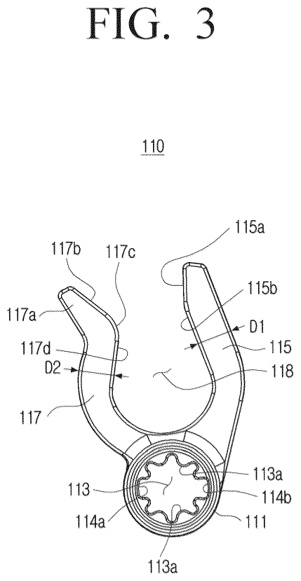

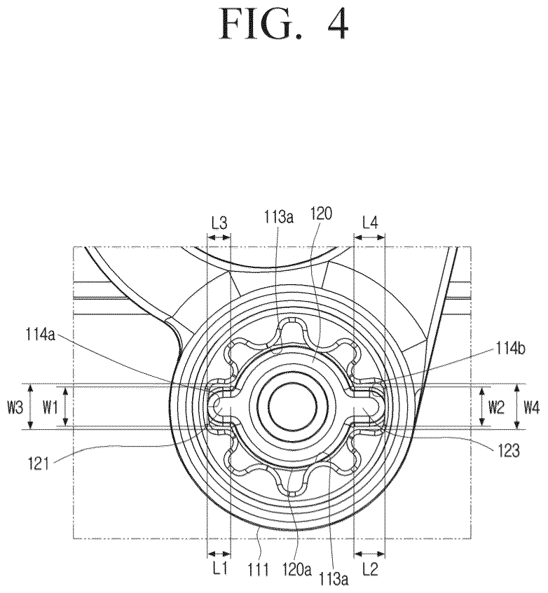

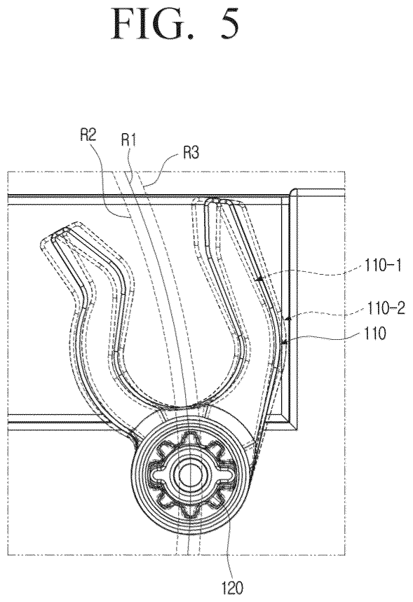

FIG. 3 is a plan view of the coupling member of the door-closing device according to one or more embodiments of the present disclosure. FIG. 4 is an enlarged view showing that the coupling member and the shaft member of the door-closing device are coupled to each other according to one or more embodiments of the present disclosure. FIG. 5 is a view showing an example in which the coupling member of the door-closing device is pivotably coupled to the shaft member within the predetermined range of angles according to one or more embodiments of the present disclosure.

Referring to FIG. 3, the coupling member 110 of the door-closing device 100 may be made of an elastic material to be able to elastically grasp the pillar part 133 of the fixing member 130. The coupling member 110 may be separated from the pillar part 133 of the fixing member 130 due to elasticity if the refrigerator compartment door 31 pivots in a direction of opening the refrigerator compartment 21.

The coupling member 110 may be disposed in such a way that the support arm 115 and the elastic arm 117 face each other while having a gap therebetween to be detachably coupled to the pillar part 133 of the fixing member 130. A coupling space 118 to which the pillar part 133 of the fixing member 130 is coupled may be disposed between side surfaces of the support arm 115 and the elastic arm 117 that face each other. In the coupling space 118, an entrance of the coupling space 118, into which the pillar part 133 of the fixing member 130 is introduced, may be approximately narrower than the inside of the coupling space 118 in which the pillar part 133 of the fixing member 130 is coupled to the arms.

A gap between the side surfaces of the support arm 115 and the elastic arm 117 that face each other may be smaller than a diameter of the pillar part 133 of the fixing member 130 to allow the pillar part 133 of the fixing member 130 to be elastically grasped by the support arm 115 and the elastic arm 117.

The support arm 115 may support the pillar part 133 of the fixing member 130 if the refrigerator compartment door 31 closes the front of the refrigerator compartment 21 by the door-closing device 100. The support arm 115 may be disposed to be further away from the hinge shaft 53 of the door than the elastic arm 117.

The support arm 115 may be tilted at a predetermined angle in a direction in which the hinge shaft 53 is disposed, as shown in FIG. 3. The support arm 115 may have a first guide surface 115a and a first support surface 115b, disposed on its side surface facing the elastic arm 117.

The first guide surface 115a may extend a predetermined length from a front end of the support arm 115 toward a rear end of the support arm 115. The first guide surface 115a may guide the introduction of the pillar part 133 of the fixing member 130 into the coupling space 118. The pillar part 133 of the fixing member 130 may be introduced into the coupling space 118 while maintaining sliding contact with the first guide surface 115a.

The first support surface 115b may be formed on a rear end side of the support arm 115 following the first guide surface 115a. The pillar part 133 of the fixing member 130 may be supported by the first support surface 115b from a moment at which the pillar part 133 is introduced into the coupling space 118.

The pillar part 133 of the fixing member 130 may be moved in a direction in which the pillar part 133 is coupled to the coupling space 118 by a pivot force that is generated in a direction in which the refrigerator compartment door 31 is closed. In this case, the elastic arm 117 may be elastically bent to be further away from the support arm 115 due to a force by which the pillar part 133 of the fixing member 130 is moved. If the pillar part 133 of the fixing member 130 is introduced into the coupling space 118 and the pillar part 133 of the fixing member 130 is not be moved, the elastic arm 117 may elastically press the pillar part 133 of the fixing member 130 while returning to its original position by an elastic force. In this case, the pillar part 133 of the fixing member 130 may have both sides of its outer peripheral surface that are pressed by the elastic arm 117 and the support arm 115. Accordingly, the refrigerator compartment door 31 may maintain a closed position where the front of the refrigerator compartment 21 is closed.

The elastic arm 117 may be bent at a predetermined angle in a direction in which a front end part 117a is disposed to be further away from the support arm 115. Accordingly, the front end part 117a of the elastic arm 117 may guide the pillar part 133 of the fixing member 130 to be introduced between the support arm 115 and the elastic arm 117.

The elastic arm 117 may have a second guide surface 117b, a protruding part 117c, and a second support surface 117d, disposed on its side surface facing the support arm 115.

The second guide surface 117b may be the side surface of the front end part 117a. The second support surface 117d may be formed on a rear end side of the elastic arm 117 following the second guide surface 117b. The pillar part 133 of the fixing member 130 may be elastically pressed by a second support surface 115d from a moment at which the pillar part 133 is introduced into the coupling space 118.

The protruding part 117c may have a curved surface and be formed at a boundary portion between the second guide surface 117b and the second support surface 117d. The elastic arm 117 may have the protruding part 117c pushed by the pillar part 133 of the fixing member 130 while the pillar part 133 of the fixing member 130 is introduced into the coupling space 118, thus causing the elastic arm 117 to be bent outwardly of the coupling member 110. In this case, the elastic arm 117 may have the elastic force that is accumulated, and firmly press the pillar part 133 of the fixing member 130 by using the accumulated elastic force from a moment at which the pillar part 133 of the fixing member 130 exceeds the protruding part 117c. Therefore, the protruding part 117c may prevent the pillar part 133 of the fixing member 130, which is introduced into the coupling space 118, from being easily separated from the coupling space 118.

The coupling member 110 shown in FIG. 3 may be installed on the door cap 60 of the left refrigerator compartment door 31 in FIG. 1. In this case, the coupling member installed on the door cap 60 of the right refrigerator compartment door 31 in FIG. 1 may be symmetrical with the coupling member 110 shown in FIG. 3.

Referring to FIG. 4, the pivoting part 111 may have an insertion hole 113 into which the shaft member 120 is inserted. A plurality of contact protrusions 113a may each have a concave-convex shape and be disposed on an inner peripheral surface of the insertion hole 113. Each front end of the plurality of contact protrusions 113a may be in contact with an outer peripheral surface 120a of the shaft member 120. It is thus possible to minimize a contact area between the insertion hole 113 of the pivoting part 111 and the outer peripheral surface 120a of the shaft member 120, thus also minimizing a frictional force occurring between the insertion hole 113 of the pivoting part 111 and the outer peripheral surface 120a of the shaft member 120. In this case, it is possible to minimize noise occurring between the insertion hole 113 of the pivoting part 111 and the outer peripheral surface 120a of the shaft member 120 and minimize wear occurring therebetween to thus secure durability of the coupling member 110 if the coupling member 110 pivots clockwise or counterclockwise.

The coupling member 110 may pivot clockwise or counterclockwise within a limited range of angles while coupled to the shaft member 120.

To limit a pivot angle of the coupling member 110, the shaft member 120 may include a first stopper 121 and a second stopper 123, which are disposed on both sides thereof, and a first limiting groove 114a into which the first stopper 121 is movably inserted and a second limiting groove 114b into which the second stopper 123 is movably inserted may be formed in the inner peripheral surface of the insertion hole 113 of the coupling member 110. A width W1 of the first stopper 121 may be smaller than a width W2 of the first limiting groove 114a, and a width W3 of the second stopper 123 may be smaller than a width W4 of the second limiting groove 114b. In this way, a clearance may be formed between the first stopper 121 and the first limiting groove 114a, and a clearance may be formed between the second stopper 123 and the second limiting groove 114b. Therefore, due to the clearances, the coupling member 110 may have pivotal freedom within the limited range of angles at which the coupling member 110 is coupled to the shaft member 120.

In this way, the coupling member 110 may pivot within the predetermined range of angles to thus overcome a left or right step that may occur between the refrigerator compartment door 31 and the main body 10, and achieve smooth coupling between the coupling member 110 and the pillar part 133 of the fixing member 130.

The coupling member coupled to the left refrigerator compartment door and the coupling member coupled to the right refrigerator compartment door may be symmetrical with each other. Therefore, the coupling members coupled to the left refrigerator compartment door and the right refrigerator compartment door may respectively correspond to the left and right refrigerator compartment doors.

The first stopper 121 and second stopper 123 of the shaft member 120 may have different lengths to prevent an operator from accidentally assembling the coupling member that does not correspond to each refrigerator compartment door. For example, as shown in FIG. 4, the first stopper 121 may have a first length L1, and the second stopper 123 may have a second length L2 that is longer than the first length L1.

In this case, a third length L3 of the first limiting groove 114a of the pivoting part 111, into which the first stopper 121 is inserted, may be equal to or similar to the first length L1. In addition, a fourth length L4 of the second limiting groove 114b of the pivoting part 111, into which the second stopper 123 is inserted, may be equal to or similar to the second length L2.

In an example, the present disclosure is described as having two stoppers, is not limited thereto, and may have only one stopper. In this case, only one limiting groove may also be formed in the pivoting part.

Referring to FIG. 5, in case that no left or right step occurs between the refrigerator compartment door 31 and the main body 10, the coupling member 110 may have a first pivot trajectory R1 if the refrigerator compartment door 31 pivots. In this case, the coupling member 110 may be stably coupled to the pillar part 133 if the coupling member 110 is coupled to the pillar part 133 of the fixing member 130.

In case that the left step occurs between the refrigerator compartment door 31 and the main body 10, the coupling member 110 may have a second pivot trajectory R2 if the refrigerator compartment door 31 pivots. In case of being coupled to the pillar part 133 of the fixing member 130, the coupling member 110 may pivot clockwise as the pillar part 133 comes into contact with the coupling member 110, thus allowing the pillar part 133 of the fixing member 130 to be stably introduced and coupled between the support arm 115 and the elastic arm 117. In this way, the coupling member 110 may have the pivotal freedom to pivot clockwise to thus complement the left step.

In addition, in case that the right step occurs between the refrigerator compartment door 31 and the main body 10, the coupling member 110 may have a third pivot trajectory R3 if the refrigerator compartment door 31 pivots. In case of being coupled to the pillar part 133 of the fixing member 130, the coupling member 110 may pivot counterclockwise as the pillar part 133 comes into contact with the coupling member 110, thus allowing the pillar part 133 of the fixing member 130 to be stably introduced and coupled between the support arm 115 and the elastic arm 117. In this way, the coupling member 110 may have the pivotal freedom to pivot counterclockwise to thus complement the right step.

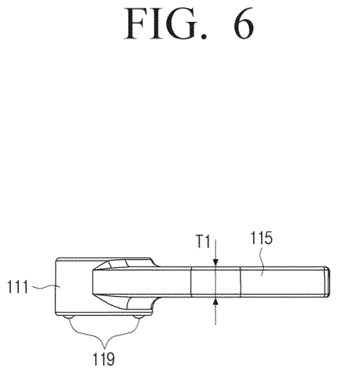

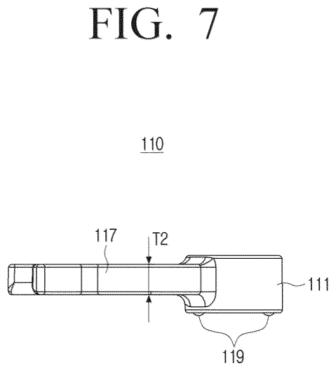

Referring to FIGS. 6 and 7, the support arm 115 may have a constant first thickness T1 from its front end to a rear end of the pivoting part 111, and the elastic arm 117 may have a constant second thickness T2 from its front end to the rear end of the pivoting part 111. In this case, the first thickness T1 of the support arm 115 and the second thickness T2 of the elastic arm 117 may be equal to or similar to each other.

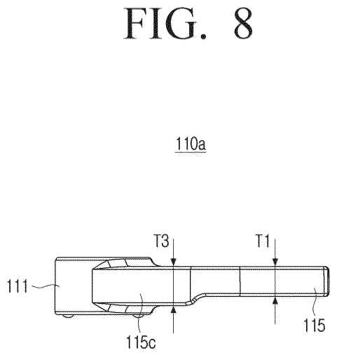

FIG. 8 is a view showing an example in which the support arm of a coupling member of the door-closing device has a different thickness according to one or more embodiments of the present disclosure.

Referring to FIG. 8, the support arm 115 of a coupling member 110a may have a front end part and a rear end part having different thicknesses. For example, a rear end part 115c of the support arm 115 may have a third thickness T3 that is greater than the first thickness T1 of the support arm 115. Accordingly, the support arm 115 of the coupling member 110a may improve its durability compared to the support arm 115 of the coupling member 110 described above.

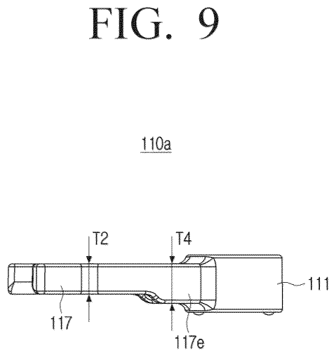

FIG. 9 is a view showing an example in which the elastic arm of the coupling member of the door-closing device has a different thickness according to one or more embodiments of the present disclosure.

Referring to FIG. 9, the elastic arm 117 of a coupling member 110a may have a front end part and a rear end part having different thicknesses. For example, a rear end part 117e of the elastic arm 117 may have a fourth thickness T4 that is greater than the second thickness T2 of the elastic arm 117. Accordingly, the elastic arm 117 of the coupling member 110a may improve its durability compared to the elastic arm 117 of the coupling member 110 described above.

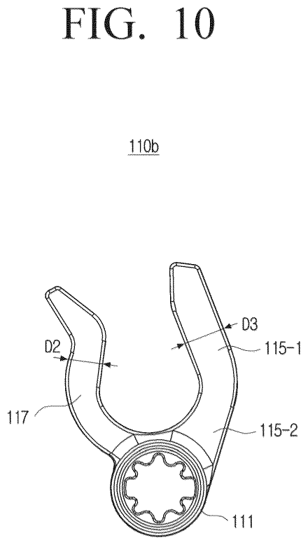

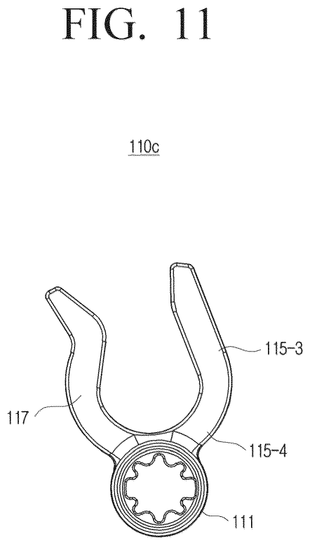

FIGS. 10 and 11 are views showing modified examples of the support arm of a coupling member of the door-closing device according to one or more embodiments of the present disclosure.

A second width D2 of the elastic arm 117 may be equal to or similar to a first width D1 of the support arm 115 (see FIG. 3). However, the first width D1 of the support arm 115 is not limited thereto. For example, as shown in FIG. 10, in the coupling member 110a, a third width D3 of a support arm 115-1 may be larger than the second width D2 of the elastic arm 117. While the pillar part 133 of the fixing member 130 is grasped by the coupling member 110, the support arm 115-1 that is required to stably support the pillar part 133 may secure its improved durability due to the increased width D3.

A coupling member 110b shown in FIG. 10 may have a width that is gradually increased as a rear end part 115-2 of the support arm 115-1 that is connected to the pivoting part 111 becomes closer to the pivoting part 111. However, the present disclosure is not limited thereto, and as shown in FIG. 11, in a coupling member 110c, a rear end part 115-4 of a support arm 115-3 that is connected to the pivoting part 111 may have an approximately constant width.

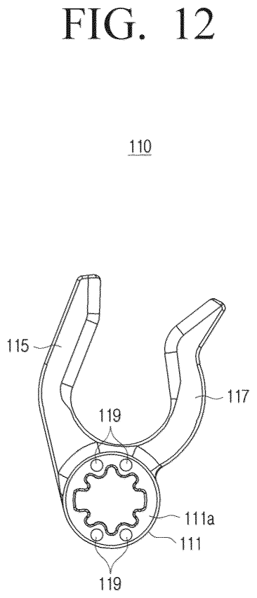

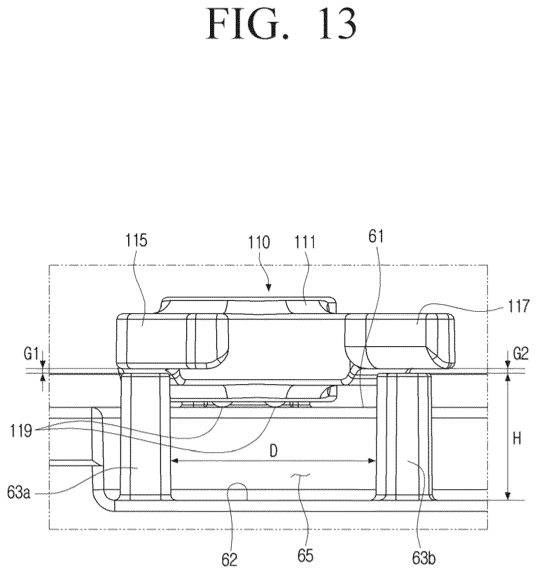

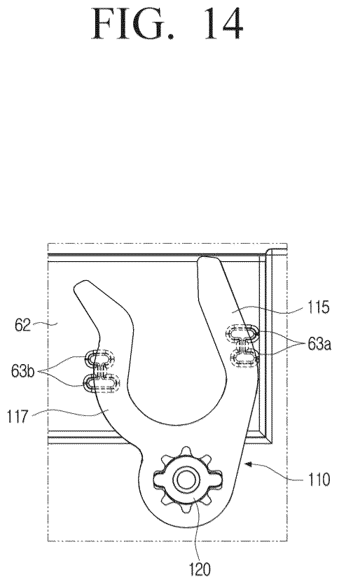

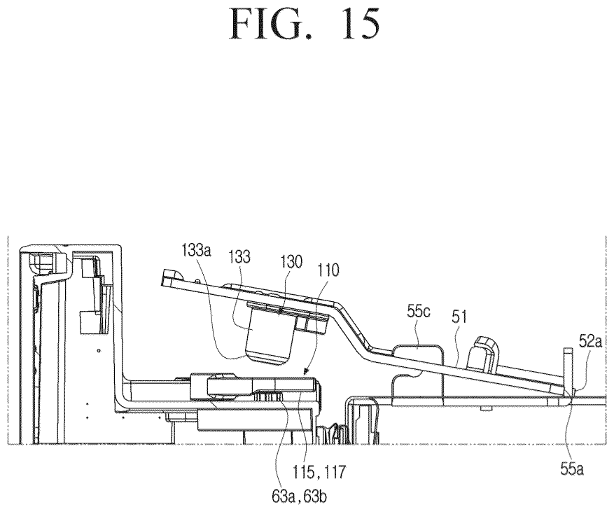

FIG. 12 is a bottom view of the coupling member of the door-closing device according to one or more embodiments of the present disclosure. FIGS. 13 and 14 are front and plan views of the coupling member of the door-closing device and the plurality of support protrusions of the door cap disposed on a lower side of the coupling member according to one or more embodiments of the present disclosure. FIG. 15 is a view showing an example of coupling the upper hinge to the main body according to one or more embodiments of the present disclosure.

Referring to FIG. 12, the pivoting part 111 of the coupling member 110 may have a plurality of contact protrusions 119 formed on a bottom 111a while having a gap therebetween.

Referring to FIG. 13, the pivoting part 111 may be seated on the seating surface 61 of the door cap 60 and pivot within the predetermined range of angles. The plurality of contact protrusions 119 formed on the bottom 111a of the pivoting part 111 may be in contact with the seating surface 61 of the door cap 60.

In this way, an area where the plurality of contact protrusions 119 in contact with the seating surface 61 of the door cap 60 may be significantly smaller than an area where the bottom 111a of the pivoting part 111 is in direct contact with the seating surface 61 of the door cap 60. It is thus possible to reduce a frictional force between the plurality of contact protrusions 119 and the seating surface 61 of the door cap 60 may be reduced, and the pivoting part 111 may thus pivot smoothly. It is also possible to minimize noise occurring between the contact protrusion 119 and the seating surface 61 of the door cap 60 if the pivoting part 111 pivots.

Referring to FIG. 13, the door cap 60 may include a groove part 65 disposed below the support arm 115 and elastic arm 117 of the coupling member 110 to prevent the pillar part 133 of the fixing member 130 from interfering with a portion of the door cap 60 if the pillar part 133 is coupled to the coupling member 110.

A first support protrusion 63a and a second support protrusion 63b may be disposed in the groove part 65 and protrude by a predetermined height H from a bottom surface 67 of the groove part 65. The first and second support protrusions 63a and 63b may have a predetermined gap D therebetween not to interfere with a movement of the pillar part 133 of the fixing member 130. The gap D between the first and second support protrusions 63a and 63b may be a gap considering the left or right step between the refrigerator compartment door 31 and the main body 10.

Referring to FIGS. 13 and 14, the first support protrusion 63a may be disposed below the support arm 115 while having a first gap G1. The second support protrusion 63b may be disposed below the elastic arm 117 while having a second gap G2. The first and second gaps G1 and G2 may allow the support arm 115 and the elastic arm 117 to pivot smoothly without friction with the first and second support protrusions 63a and 63b if the coupling member 110 pivots.

The first and second support protrusions 63a and 63b may respectively support the support arm 115 and the elastic arm 117 in case that the first and second support protrusions 63a and 63b are pressed by the pillar part 133 of the fixing member 130 if the hinge body 51 is mounted on the main body 10.

For example, the pillar part 133 of the fixing member 130 may press the support arm 115 and/or elastic arm 117 of the coupling member 110 if the hinge body 51 is mounted on the upper surface of the main body 10 as shown in FIG. 15. The first support protrusion 63a may support the bottom of the support arm 115 to prevent the support arm 115 from being bent downward or broken if the support arm 115 is pressed by the pillar part 133 of the fixing member 130. The second support protrusion 63b may support the bottom of the elastic arm 117 to prevent the elastic arm 117 from being bent downward or broken if the elastic arm 117 is pressed by the pillar part 133 of the fixing member 130.

The pillar part 133 of the fixing member 130 may have a slope 133a formed at a lower end. The lower end of the pillar part 133 may be gradually narrowed toward the bottom by the slope 133a. The pillar part 133 of the fixing member 130 may be smoothly inserted between the support arm 115 and the elastic arm 117 by minimizing interference with the support arm 115 and the elastic arm 117 if the hinge body 51 is mounted on the upper surface of the main body 10 as the slope 133a is disposed. The slope 133a may have a flat or curved surface.

In an example, the present disclosure is described as having the first and second support protrusions 63a and 63b to support the support arm 115 and the elastic arm 117, and is not limited thereto. For example, the disclosure may omit the first and second support protrusions 63a and 63b and use a structure in which a side wall of the groove part 65 protrudes to a position where the first and second support protrusions 63a and 63b are disposed. This structure may allow the seating surface 61 to extend to the lower sides of the support arm 115 and the elastic arm 117. Therefore, if the support arm 115 and the elastic arm 117 are pressed by the pillar part 133 of the fixing member 130, the arms may be supported by the seating surface 61.

Hereinafter, an operation of the door-closing device 100 according to an example of the present disclosure is described with reference to the drawings.

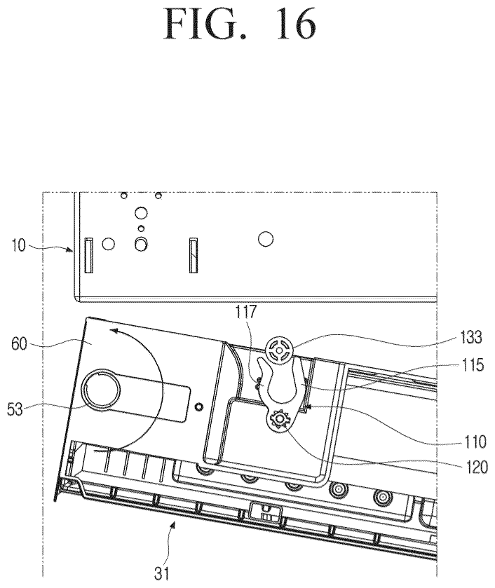

FIGS. 16 to 20 are views showing a process in which the refrigerator compartment door closes the refrigerator compartment by using the door-closing device according to one or more embodiments of the present disclosure.

Referring to FIG. 16, the refrigerator compartment door 31 may pivot clockwise around the hinge shaft 53 to close the front of the refrigerator compartment 21.

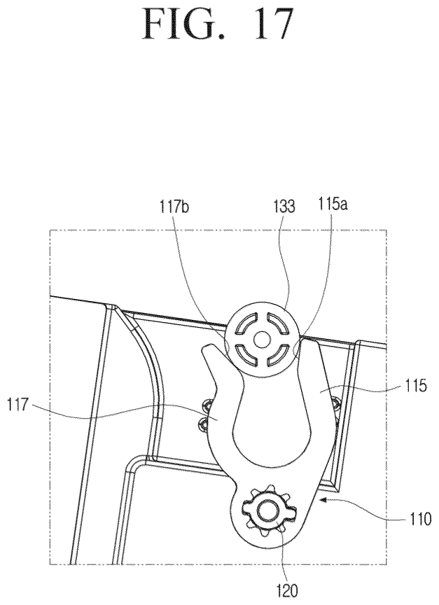

Referring to FIG. 17, the coupling member 110, which pivots together with the refrigerator compartment door 31 to be close to the main body 10, may be in contact with the pillar part 133 of the fixing member 130. In this case, the pillar part 133 of the fixing member 130 may be introduced between the support arm 115 and the elastic arm 117 by the first guide surface 115a of the support arm 115 and the second guide surface 117b of the elastic arm 117.

The coupling member 110 may pivot around the shaft member 120 within the predetermined range of angles. Therefore, even if the left or right step occurs between the refrigerator compartment door 31 and the main body 10, the pillar part 133 of the fixing member 130 may be accurately introduced between the support arm 115 and the elastic arm 117 by a pivot operation of the coupling member 110.

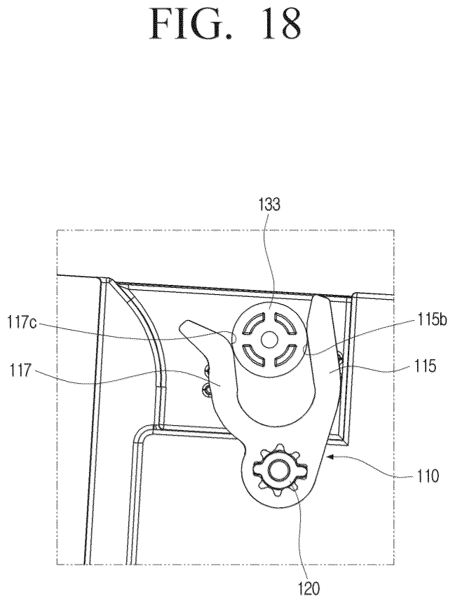

Referring to FIG. 18, if the refrigerator compartment door 31 continuously pivots counterclockwise, the pillar part 133 of the fixing member 130 may be introduced between the support arm 115 and the elastic arm 117. The elastic arm 117 may have the protruding part 117c pushed by the pillar part 133 of the fixing member 130 while the pillar part 133 of the fixing member 130 is introduced into the coupling space 118, thus causing the elastic arm 117 to be bent outwardly of the coupling member 110 and have accumulated the elastic force.

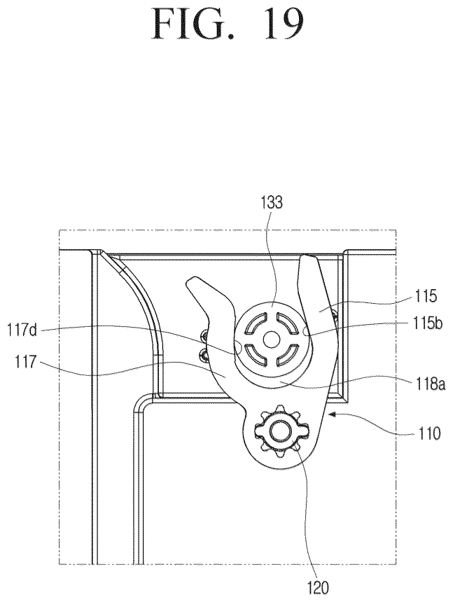

Referring to FIG. 19, the elastic arm 117 may elastically press the pillar part 133 of the fixing member 130 by using the accumulated elastic force from the moment at which the pillar part 133 of the fixing member 130 exceeds the protruding part 117c.

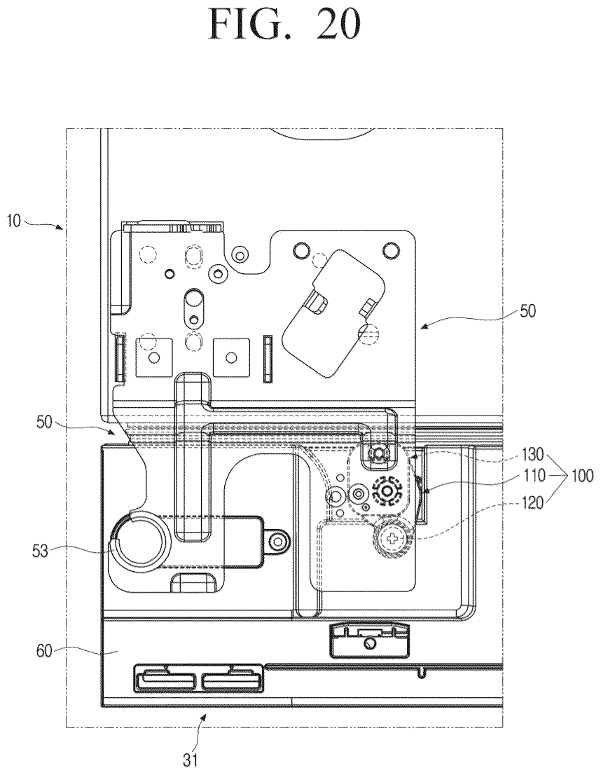

The pillar part 133 of the fixing member 130 that is introduced into the coupling space 118 may have one side supported by the first support surface 115b of the support arm 115 and the other side elastically supported by the second support surface 117d of the elastic arm 117. Therefore, the refrigerator compartment door 31 may stably close the refrigerator compartment 21 by coupling the coupling member 110 with the pillar part 133 of the fixing member 130 as shown in FIG. 20.

The coupling space 118 of the coupling member 110 may have a free space S between the inside of the coupling space 118 and the pillar part 133 of the fixing member 130 as shown in FIG. 19 while the pillar part 133 of the fixing member 130 is coupled to the coupling space 118. In this case, a forward or backward step between the refrigerator compartment door 31 and the main body 10 may be complemented by the free space S.

In addition, the pillar part 133 of the fixing member 130 may have a predetermined length for its bottom to be lower than the bottom of the support arm 115 or the elastic arm 117. Accordingly, an upward or downward step between the refrigerator compartment door 31 and the main body 10 may be complemented.

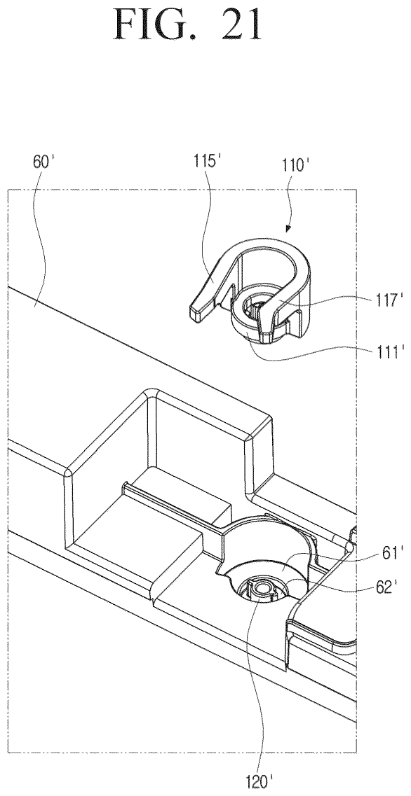

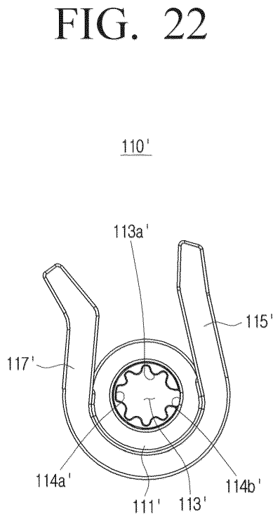

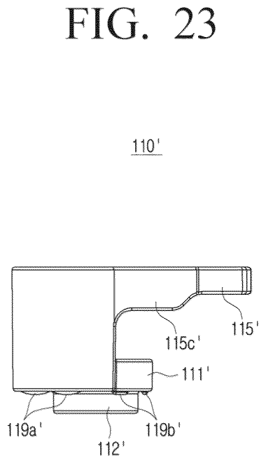

FIG. 21 is an exploded perspective view showing an example in which a coupling member of the door-closing device is coupled to the door cap according to one or more embodiments of the present disclosure. FIG. 22 is a plan view of the coupling member of the door-closing device according to one or more embodiments of the present disclosure. FIGS. 23 to 25 are the right side view, left side view, and bottom view of the coupling member of the door-closing device according to one or more embodiments of the present disclosure.

Referring to FIGS. 21 and 22, a length of a coupling member 110′ may be shorter than a length of the coupling member 110 shown in FIG. 3. Here, the length of the coupling member 110′ may be a distance from a front end of the pivoting part 111′ to a front end of the support arm 115′. In this way, the pivoting part 111′ of the coupling member 110′ may be moved to a position close to the front end of the support arm 115′ and a front end of the elastic arm 117′. As the position of the pivoting part 111′ is moved, a pivot center of the coupling member 110′ may be different from a pivot center of the coupling member 110, shown in FIG. 3.

A portion of a door cap 60′, where the coupling member 110′ is disposed, may be different from the door cap 60 shown in FIG. 2. For example, in the door cap 60′, a seating surface 61′ on which the pivoting part 111′ is seated, as shown in FIG. 21, may have a bottom surface formed in a groove shape, and a groove 62′ may be formed in the center of the seating surface 61′. A shaft member 120′ may be disposed in the groove 62′.

Referring to FIG. 23, the coupling member 110′ may have an extension 112′ protruding from the bottom of the pivoting part 111′, the extension having a diameter smaller than that of the pivoting part 111′. The extension 112′ may be inserted into the groove 62′ of the door cap 60′.

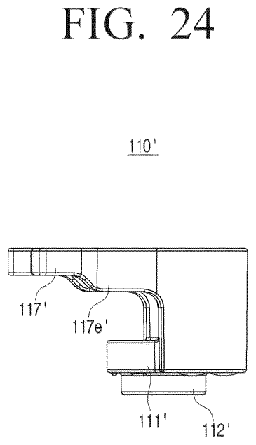

Referring to FIGS. 23 and 24, the support arm 115′ of the coupling member 110′ may have a rear end part 115c′ thicker than its front end part. Similarly, the elastic arm 117′ of the coupling member 110′ may have a rear end part 117e′ thicker than its front end part.

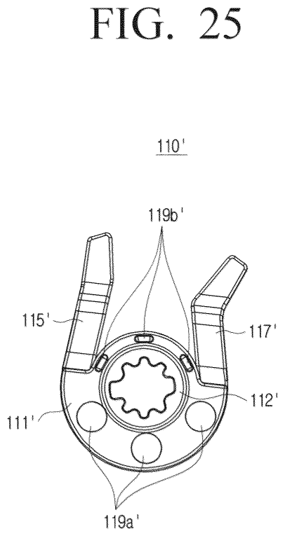

Referring to FIG. 25, the pivoting part 111′ of the coupling member 110′ may have a plurality of first contact protrusions 119a and a plurality of second contact protrusions 119b formed on the bottom to be in contact with the seating surface 61′. Each of the plurality of second contact protrusions 119b may have a smaller size than each of the plurality of first contact protrusions 119a. The reason is that a region of the seating surface 61′ that is in contact with the plurality of second contact protrusions 119b is narrower than another region of the seating surface 61 that is in contact with the plurality of first contact protrusions 119a.

While example embodiments of the disclosure have been illustrated and described, it will be understood that the embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. A refrigerator comprising:
a main body comprising a storage chamber;
one or more doors pivotably coupled to the main body and configured to open and close the storage chamber; and
a door-closing device configured to fix the one or more doors in a position that closes the storage chamber,
wherein the door-closing device comprises:
a fixing member on a top surface of the one or more doors and connected to the main body via a hinge;
a coupling member comprising a pivoting part, a first arm extending from the pivoting part, and a second arm extending from the pivoting part; and
a shaft member on the one or more doors and coupled to the pivoting part,
wherein the coupling member is configured to pivot around the shaft member within a predetermined range of angles, and
wherein the first arm supports a first side of the fixing member, and the second arm elastically presses a second side of the fixing member.

2. The refrigerator as claimed in claim 1, wherein the first arm is further away from a hinge shaft of the one or more doors than the second arm.

3. The refrigerator as claimed in claim 2, wherein a front end part of the second arm is bent toward the hinge shaft of the one or more doors, and
wherein the fixing member is between the first arm and the second arm.

4. The refrigerator as claimed in claim 3, wherein the second arm comprises a protruding part configured to press the fixing member in a direction in which the one or more doors closes the storage chamber, and
wherein the protruding part protrudes toward the first arm from a side surface of the second arm facing the first arm.

5. The refrigerator as claimed in claim 4, wherein the fixing member is inserted in a coupling space between the first arm and the second arm, and
wherein the protruding part is at an entrance of the coupling space, and the entrance is narrower than an inside of the coupling space.

6. The refrigerator as claimed in claim 1, wherein the shaft member comprises a stopper protruding toward a side of the shaft member, and
wherein the pivoting part comprises a limiting groove into which the stopper is inserted, and a width of the limiting groove is greater than a width of the stopper.

7. The refrigerator as claimed in claim 1, wherein the shaft member comprises a first stopper and a second stopper protruding toward both sides of the shaft member,
wherein the pivoting part comprises a first limiting groove and a second limiting groove into which the first stopper and the second stopper are respectively inserted,
wherein a first clearance is between the first limiting groove and the first stopper and a second clearance is between the second limiting groove and the second stopper, and
wherein a length of the first stopper is different than a length of the second stopper.

8. The refrigerator as claimed in claim 7, wherein a length of the first limiting groove corresponds to the length of the first stopper, and
wherein a length of the second limiting groove corresponds to the length of the second stopper.

9. The refrigerator as claimed in claim 1, wherein the shaft member is integrated with a door cap coupled to the top surface of the one or more doors.

10. The refrigerator as claimed in claim 1, wherein a door cap coupled to the top surface of the one or more doors comprises a first support protrusion below the first arm and a second support protrusion below the second arm, and
wherein the first support protrusion and the second support protrusion have a gap therebetween, the fixing member being allowed to pass through the gap.

11. The refrigerator as claimed in claim 10, wherein the pivoting part further comprises a plurality of contact protrusions disposed on a bottom surface of the pivoting part and contacting a seating surface of the door cap.

12. The refrigerator as claimed in claim 1, wherein the fixing member comprises a pillar part between the first arm and the second arm.

13. The refrigerator as claimed in claim 12, wherein a lower end of the pillar part is lower than a bottom surface of the first arm or the second arm.

14. A door-closing device comprising:
a fixing member fixed to a hinge of a main body of a refrigerator and comprising a pillar part;
a coupling member on a one or more doors for opening and closing a storage chamber of the main body of the refrigerator and comprising a first arm supporting a first side of the pillar part and a second arm supporting a second side of the pillar part; and
a shaft member on the one or more doors,
wherein the coupling member is pivotable around the shaft member within a predetermined range of angles,
wherein a front end part of the second arm is bent toward a hinge shaft, which is a pivot center of the one or more doors being at a portion of which the front end part of the second arm bends towards the hinge shaft, and
wherein the fixing member is between the first arm and the second arm.

15. The door-closing device as claimed in claim 14, wherein the second arm comprises a protruding part protruding toward the first arm from a side surface facing the first arm,
wherein the fixing member is inserted in a coupling space between the first arm and the second arm, and
wherein the protruding part is at an entrance of the coupling space, the entrance being narrower than an inside of the coupling space.
